(19) United States
(12) Patent Application Publication
(10) Pub. No.: US 2026/0061974 A1
(43) Pub. Date: Mar. 5, 2026

(54) DRIVE BRAKING UNIT AND VEHICLE

(71) Applicant: Continental Automotive Technologies GmbH, Hannover (DE)

(72) Inventors: Cesar Franco de Moraes, Cairo Montenetto (SV) (IT); Ivan Cecchelli, Vado Ligure (IT)

(73) Assignee: Continental Automotive Technologies GmbH, Hannover (DE)

(21) Appl. No.: 19/317,403

(22) Filed: Sep. 3, 2025

(30) Foreign Application Priority Data
Sep. 5, 2024 (DE) 10 2024 208 449.2

(51) Int. Cl. B60T 1/06; B60K 7/00; B60T 13/74; F16D 51/00; F16D 51/16; F16D 65/00; F16D 65/22; H02K 7/102

(52) U.S. Cl. CPC B60T 1/067; B60K 7/0007; B60T 13/746; F16D 51/16; F16D 65/0025; F16D 65/22; H02K 7/102; B60K 2007/0092; F16D 2051/003

(57) ABSTRACT

A drive braking unit, including a wheel hub motor and drum brake. The drum brake includes a brake drum and a braking unit in the brake drum. The drive braking unit includes a base plate to which a drive stator is fastened. The braking unit is arranged on a first side of the base plate. The braking unit is designed for mechanical connection to a vehicle's interface, which is arranged on a second side, situated opposite the first side, of the base plate. This provides a drive braking unit with an improved integration of wheel hub motor and drum brake. Between at least one component of the drum brake and an opening running through the base plate, there is arranged at least one sealing element for sealing off the first side from the second side. Thus, the drive braking unit is sealed off against water penetration and brake dust escape.

### FIELD OF THE INVENTION

The present invention relates to a drive braking unit, comprising a wheel hub motor and a drum brake, wherein the wheel hub motor comprises a drive rotor and a drive stator, and wherein the drum brake comprises a brake drum and a braking unit received in the brake drum, and wherein the drive braking unit comprises a base plate to which the drive stator is fastened, wherein the braking unit is arranged on a first side of the base plate, wherein the braking unit is configured for a mechanical connection to a vehicle interface of a vehicle, said vehicle interface being arranged on a second side of the base plate situated opposite the first side. The invention furthermore relates to a vehicle comprising at least one drive braking unit of the above mentioned type.

### BACKGROUND OF THE INVENTION

A drum brake of this kind is known for example from WO 2013 004 410 A1, incorporated by reference herein.

A further drive braking unit with a drum brake is known for example from EP 27 41 933 B1, incorporated by reference herein. An actuator mechanism and the brake shoes of the drum brake are fastened to an axially outer base of a pot-shaped stator housing. The brake drum is formed in one piece with the drive rotor.

Further wheel-integrated electric motors with an integrated drum brake are known from DE 11 2010 002 771 T5 and US 2020 044 514 A1, each incorporated by reference herein.

When drum brakes and wheel hub motors are integrated into drive braking units, the question arises as to what the expander mechanism and the brake shoes are intended to be fastened, since the steel base plate usually used alone for drum brakes also considerably increases the weight of the drive braking unit and hence the unsprung masses. At the same time, wheel hub motors are more sensitive than drum brakes when it comes to shielding from the environment.

An aspect of the invention is a drive braking unit of the above mentioned type with improved integration of wheel hub motor and drum brake.

According to an aspect of the invention, this is achieved by a drive braking unit of the above mentioned type, which is characterized in that, between at least one component of the drum brake and an opening running through the base plate, there is arranged at least one sealing element for sealing off the first side with respect to the second side.

By means of this design, it is possible for the base plate which supports the drive stator to also be used as a base plate of the braking unit of the drum brake. The drum brake thus does not comprise a separate brake anchor plate (as is generally the case with drum brakes without a wheel hub motor), but this function is performed by the base plate. The base plate, as part of the motor housing of the wheel hub motor, is then sealed off one or more times by means of the at least one sealing element between at least one component of the drum brake and an opening running through the base plate. The wheel hub motor is even more sensitive to the penetration of liquids and dirt than a drum brake alone and must therefore be particularly secured against the penetration of liquid. The sealing element furthermore allows sealing with respect to brake dust escape from the drive braking unit, whereby the fine dust emissions of the connected vehicle can be considerably lowered.

The wheel hub motor (or wheel-integrated electric motor) may be arranged in the drive braking unit so as to axially overlap the drum brake. The drum brake according to an aspect of the invention is highly suitable for integration into a drive braking unit of this kind without unnecessarily increasing the total weight of the drive braking unit due to a dedicated brake anchor plate. At the same time, a considerable reduction in service life due to ingress of liquids or dirt can be avoided. The electric motor can comprise a drive stator and a drive rotor.

A drive stator should be understood to mean that part of the stator which actively contributes to the drive, that is to say for example a winding section and an associated winding support. Accordingly, a drive rotor should be understood to mean that part of the rotor which actively contributes to the drive and, for example, bears permanent magnets, such as an inner rotor and/or an outer rotor.

In this document, “axial” or “axial direction” is to be understood as meaning the direction parallel to the axis of rotation of the vehicle wheel or of the drive braking unit or of the brake drum during operation, and “radial” or “radial direction” is to be understood as meaning the direction or directions perpendicular to said axis of rotation. In the present document, a drive braking unit is to be understood to mean a combination of a friction brake and a wheel-integrated electric motor (or wheel hub motor).

Preferred embodiments and refinements of the invention can be found in the respective dependent claims.

The braking unit is to be understood to mean, for example, an arrangement composed of one or more of the following elements: an expander device (hydraulic wheel cylinder or electromechanically driven expander device), at least one brake shoe (in particular two brake shoes) which can be displaced against the brake drum by the expander device, a restoring device for returning the brake shoes into a neutral position, a readjustment device for compensating brake lining wear, a parking brake lever for shifting the brake shoes by means of an actuating means of a parking brake fastened to the parking brake lever. According to the definition of the present application, the following are in particular not intended to be part of the braking unit: the brake drum, a parking brake actuator, an electromechanical service brake actuator and further elements of the drum brake which are arranged on the second side of the base plate. Within the context of this application, a drum brake is understood to mean a braking unit and a brake drum. Optional elements of the drum brake may for example be: a parking brake actuator, a fastening frame, for example of the parking brake actuator, an electromechanical service brake actuator.

In one embodiment, the drum brake comprises a hydraulically actuatable wheel cylinder, which is arranged on the first side on the base plate and which serves for displacing brake shoes of the braking unit against the brake drum, wherein at least one sealing element is arranged between the wheel cylinder and the base plate, such that at least one hydraulic brake line is guided in a sealed manner from the second side to the first side through a brake line opening in the base plate. It is also possible for two hydraulic brake lines to be guided and sealed by the same sealing element. It is also possible for a hydraulic line and a degassing valve to be sealed off by the same sealing element.

It is preferred if the sealing element is guided between the wheel cylinder and the base plate both around at least one hydraulic brake line and around at least one wheel cylinder fastening element in order to seal off both. The assembly of the drive braking unit is thus simplified. The sealing element may have a common interruption through which the at least one wheel cylinder fastening element and the at least one hydraulic brake line are guided.

Preferably, the wheel cylinder has a (for example rectangular) connection base which bears against the sealing element in an axial direction. The sealing element may cover the surface of the connection base except for an interruption for the hydraulic brake line and/or a degassing valve and/or the at least one wheel cylinder fastening element.

The drum brake preferably comprises an electromechanically actuatable actuator which is arranged on the second side of the base plate, wherein an actuating means extends from the actuator from the second side to the first side through an actuating means opening in the base plate, wherein the actuating means is functionally connected to the braking unit, and wherein the actuating means opening is sealed off by at least one sealing element. The electromechanically actuatable actuator can be the sole actuator of the braking unit (for example in the case of an electromechanical service brake) or merely an additional electromechanical parking brake actuator (parking brake actuator) provided (hydraulically or electromechanically) in addition to a service brake actuator.

In one embodiment, the electromechanically actuatable actuator is an electromechanical service brake actuator, in particular comprising a parking brake integrated in a transmission of the service brake actuator. Control electronics of the electromechanical service brake actuator can be arranged on or at the second side of the base plate. A service brake actuator is to be understood as meaning an actuator which not only provides a parking brake functionality but is also designed to provide, during operation, an adjustable and variable braking force by actuation of the braking unit.

The actuating means is preferably a transmission which is connected to a expander unit of the braking unit on the first side of the base plate and which extends at least partially through the actuating means opening. The expander unit can be connected at its two ends to brake shoes of the braking unit, such that the expander unit can displace the brake shoes against the brake drum in order to generate a braking torque.

In one embodiment, the electromechanically actuatable actuator is an electromechanical parking brake actuator. The electromechanical parking brake actuator can linearly displace a connected actuating means which is mechanically connected to the braking unit in order to bring one or more brake shoes into engagement with the brake drum, in particular in order to provide a parking brake function.

The drum brake preferably comprises a fastening frame, wherein the electromechanically actuatable actuator is fastened to the second side of the base plate by means of the fastening frame, wherein at least one sealing element is arranged between the fastening frame and the base plate.

The drum brake preferably comprises a fastening frame, wherein the electromechanically actuatable actuator is fastened to the second side of the base plate by means of the fastening frame, wherein at least one sealing element is arranged between the fastening frame and the base plate. The fastening frame may for example lengthen the actuating means opening on the second side of the base plate in order to realize stable guidance of an actuating means. A sealing element can then be arranged at an axial end of the actuating means opening on the second side of the base plate in order to seal off the actuating means opening between the fastening frame and the electromechanically actuatable actuator.

In a preferred embodiment
at least one sealing element is an O-ring, and/or
at least one sealing element is an overmolded O-ring, and/or
at least one sealing element is a planar sealing element (in particular a sealing diaphragm) with an opening for a leadthrough of the element to be sealed.

It is preferred if the drum brake comprises a fastening frame, wherein the parking brake actuator is fastened to the second side of the base plate by means of the fastening frame such that the actuating means runs at an angle of 10°-80°, preferably of 30°-60° and particularly preferably of 40°-50°, relative to a plane parallel to the base plate. In particular if the actuating means is a cable or similar tension element, large-angle diversions (for example by 90°) are thus avoided, which reduces the wear and the loading of the actuating means. At the same time, axial structural space can be saved if the parking brake actuator is arranged in an inclined manner (for example substantially diagonally at ˜45°) with respect to the axis of rotation of the drive braking unit and thus projects less far in the direction of the vehicle beyond the base plate.

Preferably, a guide element adjacent to the actuating means opening is arranged on the first side of the base plate, which guid element is configured to divert the actuating means between the actuating means opening and the braking unit, such that the actuating means runs between the guide element and a connection to the braking unit at an angle of 0°-30°, preferably of 0°-20° and particularly preferably of 0°-10°, relative to a plane parallel to the base plate. In this way, the actuation element can act on the braking unit (in particular on the parking brake lever) with an optimum force direction. The guide element may additionally cover a sealing element on the first side of the base plate in order to further improve the sealing. Furthermore, the guide element may also provide a rounded opening edge of the actuating means opening in order to reduce wear of the actuating means.

The actuating means preferably comprises a cable which is connected to the braking unit and which is guided through the actuating means opening. The cable may be made of a variety of metal wires.

A winding section of the drive stator of the wheel hub motor is preferably also fastened to the base plate. The base plate then has both the function of guiding the brake shoes and also supporting the winding section. The winding section can extend from the base plate substantially in the axial direction. The winding section is preferably arranged on the same side of the base plate as the brake drum and/or the braking unit. An alternating electric current can be applied to the winding section in order to generate a magnetic field which interacts with permanent magnets of the rotor in order to generate a torque between the drive rotor and the drive stator.

It is preferred if the wheel hub motor is a double-rotor radial flux motor in which the drive stator comprises a winding section arranged in a radial direction between an outer rotor having permanent magnets and an inner rotor having permanent magnets. The wheel hub motor may comprise a drive rotor which is of substantially pot-shaped design, wherein the outer rotor forms the radial outer wall of the drive rotor and the inner rotor is arranged as a flange on a pot bottom of the drive rotor. The drive rotor may be fastened together with the brake drum to a rotatable inner section of the wheel bearing.

In one embodiment, the braking unit is arranged radially inwardly, and axially substantially at the same height, as a winding section and/or an outer rotor having permanent magnets and/or an inner rotor having permanent magnets. This allows a particularly space-efficient arrangement of the braking unit, which can be optimally combined in particular with double-rotor radial flux motors of radially large construction. “Axially substantially at the same height” is to be understood as meaning that the braking unit is arranged in overlapping fashion with the respective other component over at least 50% of its axial installation length.

A wheel bearing is preferably arranged radially within the drive stator and in an axially overlapping manner with the drive stator, wherein a fixed outer ring (outer bearing) of the wheel bearing is connected to the base plate. A rotatable inner section of the wheel bearing may be connected to the brake drum and/or to the drive rotor.

An aspect of the invention is also achieved by a vehicle comprising at least one drive braking unit according to any one of the preceding embodiments.

Further details of aspects of the invention are set forth in the description of the illustrated exemplary embodiments and in the appended claims.

### BRIEF DESCRIPTION OF THE DRAWINGS

FIG. 1 shows an isometric, partially exploded illustration of an embodiment of a drive braking unit according to the invention with the detail of the connection of the wheel cylinder to the base plate,

FIG. 2 shows an isometric, partially exploded illustration of an embodiment of a drive braking unit according to the invention with the detail of the connection of the parking brake actuator to the base plate,

FIG. 3 shows an isometric, partially exploded illustration of the fastening frame and the base plate according to FIG. 2,

FIG. 4 shows a sectional illustration through a connected parking brake actuator, fastening frame and base plate corresponding to FIG. 2,

FIG. 5 shows an isometric, partially exploded illustration of a further embodiment of a drive braking unit according to the invention, with the detail of a guide element on the first side of the base plate for an actuation element,

FIG. 6 shows a view of a guide element in an embodiment slightly modified with respect to FIG. 5, here seen along the axial direction.

### DETAILED DESCRIPTION OF EXEMPLARY EMBODIMENTS

In the following detailed description of preferred embodiments, identical reference signs denote substantially identical or identical parts in or on these embodiments. To better illustrate the invention, the preferred embodiments illustrated in the figures are however not always illustrated to scale.

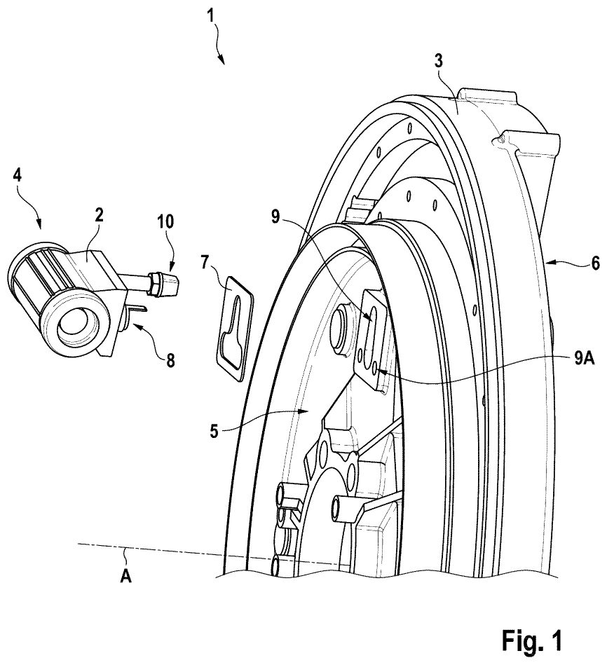

FIGS. 1 to 6 show embodiments and components of drive braking units 1 according to the invention comprising a wheel-integrated electric motor and a drum brake arranged so as to overlap axially with the electric motor. For the sake of clarity, components of the drive braking unit 1 which are not essential for the explanation of the invention are not illustrated in the figures.

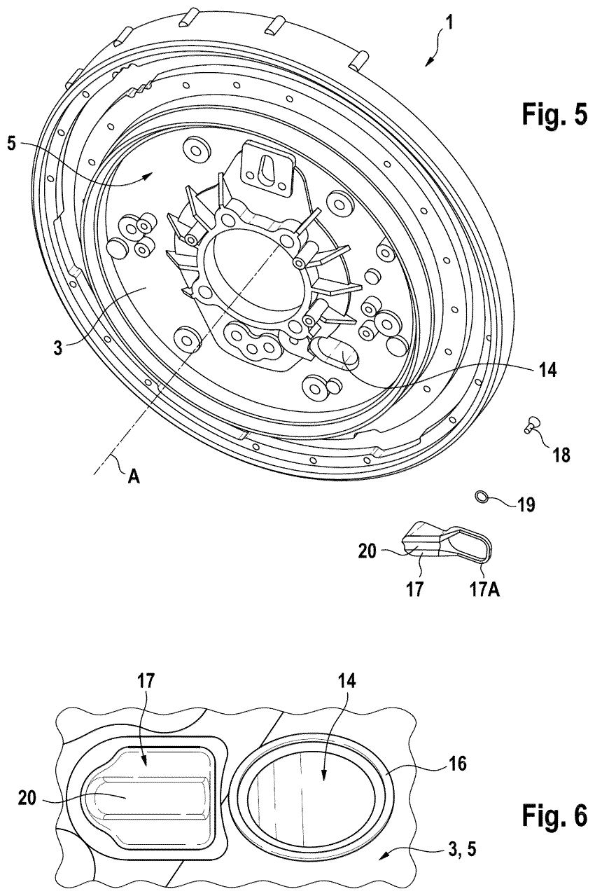

As can be seen in FIG. 1, the drum brake comprises an expander mechanism, here in the form of a wheel cylinder 2. The drive braking unit 1 comprises a base plate 3 which both supports the drive stator with a winding section and serves as the base of a braking unit 4 of the drum brake. The braking unit 4 is arranged on a first side 5 of the base plate 3. A central axis of rotation A of the drive braking unit 1, or in particular of the drive rotor and of the brake drum, is indicated in FIGS. 1 and 5.

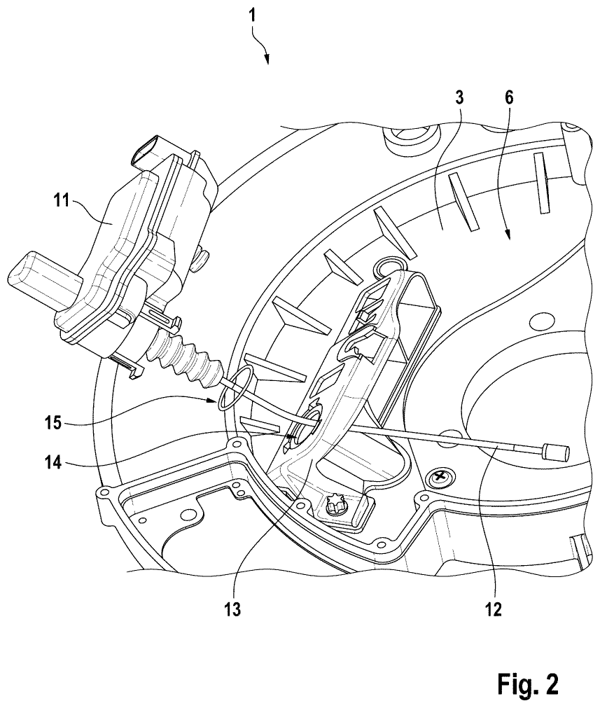

Between at least one component of the drum brake and an opening running through the base plate 3, at least one sealing element is arranged for sealing the first side 5 with respect to one of the second side 6 (better seen in FIG. 2).

Corresponding to FIG. 1, a hydraulically actuatable wheel cylinder 2, which is arranged on the base plate 3 on the first side 5, is designed for displacing brake shoes of the braking unit 4 against the brake drum. A sealing element 7 (sealing diaphragm or flat sealing element) is arranged between the wheel cylinder 2 and the base plate 3. In this way, a hydraulic brake line is or can be guided in a sealed manner from the second side 6 through a brake line opening 9 in the base plate 3 to a hydraulic connection 8. Here, a degassing valve 10 is also provided. The sealing element 7 is guided between the wheel cylinder 2 and the base plate 3 both around the hydraulic connection 8 and around two wheel cylinder fastening elements and the degassing valve 10 in order to jointly seal off all of the above mentioned elements. The wheel cylinder fastening elements are not illustrated, but there are two fastening element openings 9A adjacent to the brake line opening 9.

FIG. 2 shows the integration of an electromechanical parking brake actuator 11 into the base plate 3. The electromechanical parking brake actuator 11 can linearly displace a connected actuating means 12 (in this case comprising a cable). The actuating means 12 is mechanically connected to the braking unit 4 (in particular to a parking brake lever) in order to bring one or more brake shoes into engagement with the brake drum, in particular in order to provide a parking brake function.

Here, the drum brake furthermore comprises a fastening frame 13, wherein the parking brake actuator 11 is fastened to the second side 6 of the base plate 3 by means of the fastening frame 13. The fastening frame 13 extends an actuating means opening 14 on the second side 6 of the base plate 3 in order to realize stable guidance of an actuating means 12. A sealing element 15 (O-ring or overmolded O-ring) is arranged at an axial end of the actuating means opening 14 in order to seal off the actuating means opening 14 between the fastening frame 13 and the parking brake actuator 11. Here, for better clarity of the actuating means opening 14, the fastening frame 13 is illustrated partially in section, and the actuating means 12 is illustrated guided through the remote wall of the actuating means opening 14 only for improved clarity. In the mounted state, that end of the actuating means 12 which is functionally connected to the braking unit 4 is arranged on the first side 5 of the base plate 3.

The parking brake actuator 11 is fastened to the second side 6 of the base plate 3 by means of the fastening frame 13 such that the actuating means 12 runs at an angle of particularly preferably 40°-50° relative to a plane parallel to the base plate 3. In particular if the actuating means 12 is a cable or similar tension element, large-angle deviations (for example by 90°) are thus avoided, which reduces the wear and the loading of the actuating means 12. At the same time, axial structural space can be saved if the parking brake actuator 11 is arranged in an inclined manner (for example substantially diagonally at ˜45°) with respect to the axis of rotation 1 of the drive braking unit and thus projects less far in the direction of the vehicle beyond the base plate 3.

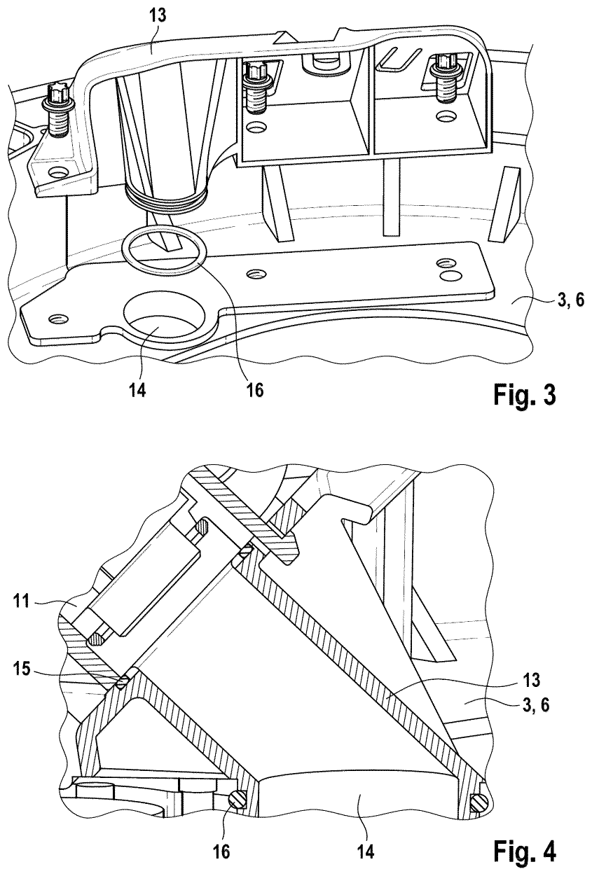

As illustrated in FIGS. 3 and 4, a (further) sealing element 16 (O-ring) is arranged between the fastening frame 13 and the base plate 3.

As illustrated in FIGS. 5 and 6, on the first side 5 of the base plate 3, there is arranged a guide element 17 which is adjacent to the actuating means opening 14 and which is configured to deflect the actuating means 12 between the actuating means opening 14 and the braking unit 4. In this way, the actuating means 12 runs, between the guide element 17 and a connection to the braking unit 4, at an angle of preferably 0°-10°, relative to a plane parallel to the base plate.

As illustrated in FIG. 5, the guide element 17 can additionally cover the sealing element 16 on the first side 5 of the base plate 3 by comprising a loop 17A which corresponds to the opening contour of the actuating means opening 14 on the first side 5, in order to further improve the sealing. For this purpose, the guide element 17 may be fastened as a separate component to the base plate 3, in particular by means of a fastening means 18 (in this case a screw) using a sealing element 19 (O-ring).

In FIG. 6, the guide element 17 is formed integrally with the base plate 3.

In both embodiments of FIGS. 5 and 6, the guide element comprises a guide notch 20 for guiding the actuating means 12, in particular if it comprises a cable.

### LIST OF REFERENCE NUMERALS

1 drive braking unit
2 wheel cylinder
3 base plate
4 braking unit
5 first side
6 second side
7 sealing element
8 hydraulic connection
9 brake line opening
9A fastening element opening
10 degassing valve
11 parking brake actuator
12 actuating means
13 fastening frame
14 actuating means opening
15 sealing element
16 sealing element
17 guide element
17A loop
18 fastening element
19 sealing element
20 guide notch
A rotation axis

1. A drive braking unit, comprising a wheel hub motor and a drum brake,
wherein the wheel hub motor comprises a drive rotor and a drive stator,
and wherein the drum brake comprises a brake drum and a braking unit accommodated in the brake drum,
and wherein the drive braking unit comprises a base plate which the drive stator is fastened,
wherein the braking unit is arranged on a first side of the base plate, wherein the braking unit is configured for a mechanical connection to a vehicle interface of a vehicle, arranged on a second side (6) of the base plate lying opposite the first side,
wherein at least one sealing element for sealing off the first side with respect to the second side is arranged between at least one component of the drum brake and an opening running through the base plate.

2. The drive braking unit according to claim 1, wherein the drum brake comprises a hydraulically actuatable wheel cylinder, which is arranged on the first side on the base plate and which serves for displacing brake shoes of the braking unit against the brake drum, wherein at least one sealing element is arranged between the wheel cylinder and the base plate, such that at least one hydraulic brake line is guided in a sealed manner from the second side through a brake line opening in the base plate to the first side.

3. The drive braking unit according to claim 2, wherein the sealing element is guided between the wheel cylinder and the base plate both around at least one hydraulic brake line and around at least one wheel cylinder fastening element in order to seal off both.

4. The drive braking unit according to claim 1, wherein the drum brake comprises an electromechanically actuatable actuator which is arranged on the second side of the base plate, wherein an actuator extends from the actuator from the second side to the first side through an actuator opening in the base plate, wherein the actuator is connected to the braking unit in a functional actuating connection and wherein the actuator opening is sealed off by at least one sealing element.

5. The drive braking unit according to claim 4, wherein the electromechanically actuatable actuator is an electromechanical service brake actuator, in particular comprising a parking brake integrated into a transmission of the service brake actuator.

6. The drive braking unit according to claim 5, wherein the actuator is a transmission which is connected to a expander unit of the braking unit on the first side of the base plate and extends at least partially through the actuator opening.

7. The drive braking unit according to claim 4, wherein the electromechanically actuatable actuator is an electromechanical parking brake actuator.

8. The drive braking unit according to claim 4, wherein the drum brake comprises a fastening frame wherein the electromechanically actuatable actuator is fastened to the second side of the base plate of the fastening frame wherein at least one sealing element arranged between the fastening frame and the base plate.

9. The drive braking unit according to claim 7, wherein the drum brake comprises a fastening frame, wherein the electromechanically actuatable actuator is fastened to the second side of the base plate by the fastening frame, wherein at least one sealing element is arranged between the fastening frame and the electromechanically actuatable actuator.

10. The drive braking unit according to claim 1, wherein
at least one sealing element is an O-ring, and/or
at least one sealing element is an overmolded O-ring, and/or
at least one sealing element a planar sealing element with an opening for a leadthrough of the element to be sealed.

11. The drive braking unit according to claim 7, wherein the drum brake comprises a fastening frame, wherein the parking brake actuator is fastened to the second side of the base plate by the fastening frame such that the actuator extends at an angle of 10°-80°, preferably of 30°-60° and particularly preferably of 40°-50°, relative to a plane parallel to the base plate.

12. The drive braking unit according to claim 7, wherein, on the first side of the base plate, there is arranged a guide element which is adjacent to the actuator opening and which is configured to divert the actuator between the actuator opening and the braking unit such that the actuator between the guide element and a connection to the braking unit extends at an angle of 0°-30°, preferably of 0°-20° and particularly preferably of 0°-10°, relative to a plane parallel to the base plate.

13. The drive braking unit according to claim 7, wherein the actuator comprises a cable which is connected to the braking unit and which is passed through the actuator opening.

14. The drive braking unit according to claim 1, wherein the wheel hub motor is a double-rotor radial flux motor, in which the drive stator comprises a winding section arranged in a radial direction between an outer rotor with permanent magnets and an inner rotor with permanent magnets.

15. The drive braking unit according to claims, claim 1, wherein the braking unit is arranged radially inwardly, and axially substantially at the same height as the drive stator, and/or an external rotor having permanent magnets and/or an inner rotor having permanent magnets.

16. The drive braking unit according to claim 1, wherein a wheel bearing is arranged radially within the drive stator and in an axially overlapping manner with the drive stator, wherein a fixed outer ring of the wheel bearing is connected to the base plate.

17. A vehicle comprising at least one drive braking unit according to claim 1.
